(19) United States
(12) Patent Application Publication
(10) Pub. No.: US 2026/0034804 A1
(43) Pub. Date: Feb. 5, 2026

(54) INKJET HEAD ALIGNMENT UNIT AND SUBSTRATE TREATING APPARATUS

(71) Applicant: SEMES CO., LTD., Cheonan-si (KR)

(72) Inventors: Jin Woo YANG, Gyeonggi-do (KR); Jee Yong JUNG, Chungcheongnam-do (KR)

(73) Assignee: SEMES CO., LTD., Cheonan-si (KR)

(21) Appl. No.: 19/225,175

(22) Filed: Jun. 2, 2025

(30) Foreign Application Priority Data
Aug. 2, 2024 (KR) 10-2024-0102949

(51) Int. Cl. B41J 3/54; B41J 25/00; B41J 25/304

(52) U.S. Cl. CPC B41J 3/543; B41J 25/001; B41J 25/304

(57) ABSTRACT

An inkjet head alignment apparatus that are capable of automatically and easily aligning heads without manual work includes: a drive device configured to align heads for ejecting a substrate treating liquid; and a connection module configured to constrain the heads to the drive device, wherein the drive device is configured to form movement in at least two directions among a first direction, a second direction orthogonal to the first direction on a horizontal plane, and a third direction perpendicular to the first direction in an upward direction, and the connection module comprises: guide pins provided on the heads and protruding in the third direction; and bush units provided on the drive device and configured to constrain movement in a circumferential direction, including the first and second directions, by receiving the guide pins therein.

### CROSS-REFERENCE TO RELATED APPLICATION

This application claims priority from Korean Patent Application No. 10-2024-0102949 filed on Aug. 2, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to an inkjet head alignment unit and a substrate treating apparatus.

### 2. Description of the Related Art

The manufacture of a display may include a plurality of treating processes for forming light-emitting elements on a substrate (e.g., a transparent glass), and as one of the treating processes, there is an inkjet printing process for forming a film or a pattern by ejecting droplets of ink, which serves as a substrate treating liquid, onto the substrate.

The inkjet printing process is performed by ejecting ink onto a substrate. To eject ink onto a substrate, an inkjet printing apparatus, serving as a substrate treating apparatus, is installed in a display manufacturing factory, and the inkjet printing process is performed on the substrate by the inkjet printing apparatus.

In addition, when manufacturing a large display, tens to hundreds of heads are provided in a single substrate treating apparatus to shorten the processing time. Furthermore, when an inkjet printing system is used in the process of printing a color filter having three colors of red (R), green (G), and blue (B), tens of heads must be used for each color to shorten the processing time.

When using an inkjet printing apparatus as a substrate treating apparatus, to ensure that ink ejected from heads is accurately applied to each desired position, the nozzles of each head must be provided at positions corresponding to the respective dots, i.e., at designed positions, at the time of ink ejection, and if the nozzle positions deviate from the designed positions, the ink is sprayed onto incorrect positions. Thus, when a plurality of heads are used, the alignment of the heads becomes an important factor for quality and productivity.

### SUMMARY

An objective of the present disclosure is to provide an inkjet head alignment apparatus and a substrate treating apparatus that are capable of automatically and easily aligning heads without manual work.

The objectives of the present disclosure are not limited to those mentioned above, and other objectives not explicitly stated will be clearly understood by those skilled in the art based on the following description.

According to an aspect of the present disclosure, an inkjet head alignment apparatus includes: a drive device configured to align heads for ejecting a substrate treating liquid; and a connection module configured to constrain the heads to the drive device, wherein the drive device is configured to form movement in at least two directions among a first direction, a second direction orthogonal to the first direction on a horizontal plane, and a third direction perpendicular to the first direction in an upward direction, and the connection module comprises: guide pins provided on the heads and protruding in the third direction; and bush units provided on the drive device and configured to constrain movement in a circumferential direction, including the first and second directions, by receiving the guide pins therein.

According to an aspect of the present disclosure, an inkjet head alignment apparatus includes: a sensor module comprising a first vision camera arranged closer to first ends than to second ends of heads configured to eject a substrate treating liquid provided for a color filter, and a second vision camera arranged closer to the second ends than to the first ends of the heads, the sensor module being configured to detect nozzles of the heads; a drive device configured to align the heads in a pack such that positions of the nozzles detected by the sensor module match preset positions set as correct positions of the nozzles; and a connection module configured to constrain the heads to the drive device, wherein the drive device comprises: a first multi-axis motor module provided at the first ends of the heads; and a second multi-axis motor module provided at the second ends of the heads, each of the first and second multi-axis motor modules comprises: a first motor unit configured to form movement in a first direction; a second motor unit configured to form movement in a second direction orthogonal to the first direction on a horizontal plane; and a third motor unit configured to form movement in a third direction perpendicular to the first direction in an upward direction, the connection module comprises: guide pins provided on the heads, protruding in the third direction, and having a circular truncated cone shape tapered to have a smaller diameter toward their tops, wherein each of the guide pins is provided on a same center axis as a bolt hole provided in a corresponding head for bolting the corresponding head to a pack and has a first through-hole with the same diameter as or a larger diameter than the bolt hole; and bush units provided on the drive device, configured to move in an up-down direction by operation of the third motor units of the first and second multi-axis motor modules, configured to constrain the guide pins when the guide pins are inserted thereinto and thereby constrain movement in a circumferential direction, including the first and second directions, and have a greater height than the guide pins, and each of the bush units comprises: a detachable body fitted onto a corresponding guide pin, extending in the third direction, and having a second through-hole penetrating in the up-down direction at a position facing the first through-hole; and a connector configured to connect the detachable body to the drive device.

According to another aspect of the present disclosure, an substrate treating apparatus includes: a process treating unit configured to support a substrate; an inkjet head unit comprising heads configured to eject a substrate treating liquid onto the substrate and arranged in a pack; and a substrate treating liquid supply unit configured to supply the substrate treating liquid to the inkjet head unit, wherein the heads are aligned by the inkjet head alignment apparatus.

The inkjet head alignment apparatus and substrate treating apparatus according to the present disclosure may enable automatic alignment of the heads without manual work, thereby reducing working time and labor requirements. In addition, when bolts are fastened to the pack to install the heads, the bush units may constrain the heads, thereby reducing or preventing distortion caused by the fastening torque of the bolts and improving product quality.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a plan view illustrating a substrate treating apparatus according to some embodiments of the present disclosure;

FIG. 2 is a perspective view illustrating the inkjet head unit and the inkjet head alignment apparatus of the substrate treating apparatus according to some embodiments of the present disclosure;

FIG. 3 is a front view illustrating the inkjet head unit and the inkjet head alignment apparatus of the substrate treating apparatus according to some embodiments of the present disclosure;

FIG. 4 is a plan view illustrating the inkjet head unit and the inkjet head alignment apparatus of the substrate treating apparatus according to some embodiments of the present disclosure;

FIG. 5 is a side view illustrating the inkjet head unit and the inkjet head alignment apparatus of the substrate treating apparatus according to some embodiments of the present disclosure;

FIG. 6 is a view illustrating an inkjet head alignment apparatus according to a first embodiment of the present disclosure;

FIG. 7 is a view illustrating a state where a third motor unit of the inkjet head alignment apparatus according to the first embodiment of the present disclosure operates;

FIG. 8 is a view illustrating a state where a first motor unit of the inkjet head alignment apparatus according to the first embodiment of the present disclosure operates;

FIG. 9 is a view illustrating a state where a second motor unit of the inkjet head alignment apparatus according to the first embodiment of the present disclosure operates;

FIG. 10 is a front view illustrating the inkjet head unit and a bush of the substrate treating apparatus according to some embodiments of the present disclosure;

FIG. 11 is an enlarged view illustrating region A of FIG. 10;

FIG. 12 is a front view illustrating a state where the bush is fitted into the inkjet head unit of the substrate treating apparatus according to some embodiments of the present disclosure;

FIG. 13 is a front view illustrating a process of coupling a bolt to the inkjet head unit of the substrate treating apparatus according to some embodiments of the present disclosure;

FIG. 14 is a front view illustrating a state where the bolt is coupled to the inkjet head unit of the substrate treating apparatus according to some embodiments of the present disclosure;

FIG. 15 is a view illustrating a state where a plurality of heads are aligned;

FIG. 16 is a view illustrating a screen of a display device linked to a sensor module of an inkjet head alignment apparatus according to some embodiments of the present disclosure;

FIG. 17 is a view illustrating a state before heads are aligned in the substrate treating apparatus according to some embodiments of the present disclosure;

FIG. 18 is a view illustrating a state where movement in a second direction is formed in the substrate treating apparatus according to some embodiments of the present disclosure;

FIG. 19 is a view illustrating a state where movement in a first direction is formed in the substrate treating apparatus according to some embodiments of the present disclosure; and

FIG. 20 is a view illustrating a state where movement in a first rotational direction is formed in the substrate treating apparatus according to some embodiments of the present disclosure.

### DETAILED DESCRIPTION

Embodiments of the present disclosure will hereinafter be described in detail with reference to the accompanying drawings. Advantages and features of the present disclosure, and methods of achieving them, will become apparent with reference to the embodiments to be described below together with the accompanying drawings. However, the present disclosure is not limited to the embodiments set forth below and may be embodied in various different forms. The embodiments are provided only to complete the present disclosure and to fully convey the scope of the invention to one of ordinary skill in the art, and the present disclosure is defined only by the scope of the appended claims. Throughout the specification, like reference numerals refer to like elements.

The terminology used herein is for the purpose of describing embodiments only and is not intended to be limiting of the present disclosure. In this specification, the singular forms include plural forms as well, unless the context clearly indicates otherwise. It should also be understood that the terms “comprises” and/or “comprising,” when used herein, specify the presence of stated features, integers, steps, operations, elements, and/or components but do not preclude the presence or addition of one or more other features, integers, steps, operations, elements, components, and/or groups thereof.

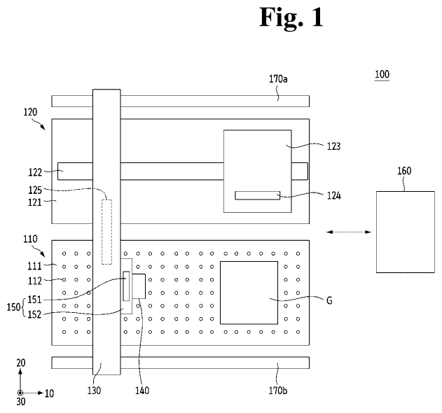

FIG. 1 is a plan view illustrating a substrate treating apparatus according to some embodiments of the present disclosure.

Referring to FIG. 1, a substrate treating apparatus 100 may include a process treating unit 110, a maintenance unit 120, a gantry unit 130, an inkjet head unit 140, a substrate treating liquid supply unit 150, and a controller 160.

The substrate treating apparatus 100 is for treating a substrate G (e.g., transparent glass) used in the manufacture of a display device. The substrate treating apparatus 100 may perform a printing process on the substrate G by ejecting a substrate treating liquid onto the substrate G using the inkjet head unit 140.

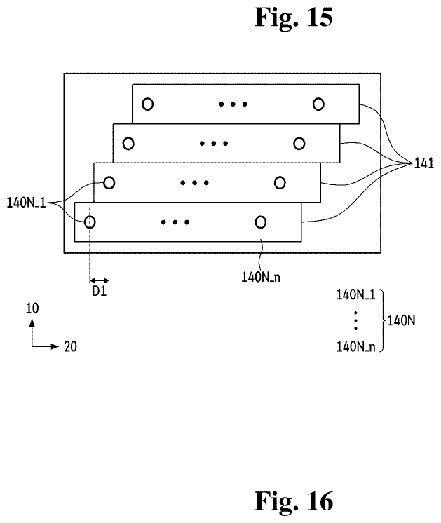

The substrate treating apparatus 100 may use a substrate treating liquid. Here, the substrate treating liquid may be ink as a chemical liquid used for printing treatment of the substrate G. In other words, the substrate treating apparatus 100 may be provided as an inkjet printing apparatus that forms a color filter CF on the substrate G using ink. The substrate treating apparatus 100 may perform pixel printing on the substrate G using the substrate treating liquid, and may be provided as a circulation-type inkjet printing apparatus to prevent nozzles (“140N” in FIG. 15) from clogging due to the substrate treating liquid, but is not limited thereto.

The process treating unit 110 supports the substrate G while the substrate G is being printed using the substrate treating liquid. The process treating unit 110 may support the substrate G using a non-contact method. For example, the process treating unit 110 may support the substrate G by levitating the substrate G using air, but the present disclosure is not limited thereto. Alternatively, the process treating unit 110 may support the substrate G using a contact method.

The process treating unit 110 may move the substrate G while supporting the substrate G using air. For example, the process treating unit 110 may include a first stage 111 and air holes 112.

The first stage 111 may be provided to allow the substrate G to be placed thereon. The air holes 112 may be formed to penetrate the first stage 111. A plurality of air holes 112 may be formed within a printing zone on the first stage 111.

The air holes 112 may spray air in the upward direction of the first stage 111, i.e., a third direction 30. Through this, the air holes 112 may float the substrate G placed on the first stage 111.

Although not illustrated, the process treating unit 110 may further include a gripping unit and a guide rail. When the substrate G moves along the longitudinal direction of the first stage 111, i.e., a first direction 10, the gripping unit may grip the substrate G to prevent the substrate G from departing from the first stage 111. When the substrate G moves, the gripping unit may move in the same direction as the substrate G while gripping the substrate G along the guide rail. The gripping unit and the guide rail may be provided outside the first stage 111.

The maintenance unit 120 measures ejection positions (i.e., dotting points) and the ejection status of the substrate treating liquid on the substrate G. The maintenance unit 120 may measure the ejection positions and/or the ejection status of the substrate treating liquid for each of a plurality of nozzles 140N provided in the inkjet head unit 140, and the relevant measurement results may be provided to the controller 160.

For example, the maintenance unit 120 may include a second stage 121, a third guide rail 122, a first plate 123, a calibration board 124, and a camera module 125.

The second stage 121 may be arranged parallel to the first stage 111. The second stage 121 may include a maintenance zone on its upper surface. The second stage 121 may be provided to have the same size as the first stage 111. Alternatively, the second stage 121 may be provided to have a smaller or larger size than the first stage 111.

The third guide rail 122 guides the movement path of the first plate 123. The third guide rail 122 may be provided on the second stage 121 as at least one line along the longitudinal direction of the second stage 121, i.e., along the first direction 10. The third guide rail 122 may be implemented as, for example, a linear motor guide system.

Although not illustrated, the maintenance unit 120 may further include a fourth guide rail. Like the third guide rail 122, the fourth guide rail guides the movement path of the first plate 123 and may be provided on the second stage 121 as at least one line along the width direction of the second stage 121, i.e., a second direction 20.

The first plate 123 may move on the second stage 121 along the third guide rail 122 and/or the fourth guide rail. The first plate 123 may move parallel to the substrate G along the third guide rail 122, and may approach or move away from the substrate G along the fourth guide rail.

The calibration board 124 is for measuring the ejection position of the substrate treating liquid on the substrate G. The calibration board 124 may be installed on the first plate 123 to measure the ejection position of the substrate treating liquid, and may include a plurality of alignment marks, a ruler, etc., and may be provided along the longitudinal direction of the first plate 123, i.e., along the first direction 10.

Meanwhile, the calibration board 124 may also be provided at a position close to the inkjet head unit 140 together with measuring equipment (e.g., a camera module 125) installed to check the ejection status of the substrate treating liquid. For example, the calibration board 124 and the measuring equipment may be installed on the gantry unit 130.

The camera module 125, which is an optical device, is for acquiring image information on the substrate G. The image information acquired by the camera module 125 may include information on position alignment of the substrate G before printing, whether the substrate treating liquid is being ejected during printing, the ejection position of the substrate treating liquid, the ejection amount of the substrate treating liquid, the ejection area of the substrate treating liquid, and/or dotting accuracy. Meanwhile, the camera module 125 may acquire not only image information on the substrate G, onto which the substrate treating liquid has been ejected, but also information on the calibration board 124 and provide the acquired information.

The camera module 125 may acquire image information on the substrate G in real time during the treatment of the substrate G. The camera module 125 may acquire image information by capturing an image of the substrate G in the first direction 10, in which case, the camera module 125 may include a line scan camera. The camera module 125 may also acquire image information by capturing an image of the substrate G in units of regions of a predetermined size, in which case, the camera module 125 may include an area scan camera.

The camera module 125 may be attached to the bottom surface or a side surface of the gantry unit 130 to acquire image information on the substrate G, onto which the substrate treating liquid has been ejected, but the present disclosure is not limited thereto. The camera module 125 may also be attached to a side surface of the inkjet head unit 140. Various modifications are possible such as fixedly or movably installing the camera module 125.

The gantry unit 130 supports the inkjet head unit 140. The gantry unit 130 may be provided above the first and second stages 111 and 121 so that the inkjet head unit 140 may eject the substrate treating liquid onto the substrate G.

The gantry unit 130 may be provided on the first and second stages 111 and 121 with the width direction of the first and second stages 111 and 121, i.e., the second direction 20, as its longitudinal direction. The gantry unit 130 may move in the longitudinal direction of the first and second stages 111 and 121, i.e., in the first direction 10, along a first guide rail 170a and a second guide rail 170b. The first and second guide rails 170a and 170b may be provided outside the first and second stages 111 and 121 along the longitudinal direction of the first and second stages 111 and 121, i.e., along the first direction 10.

Although not illustrated, the substrate treating apparatus 100 may further include a gantry moving unit. The gantry moving unit slides the gantry unit 130 along the first and second guide rails 170a and 170b. The gantry moving unit may be installed inside the gantry unit 130 and may include a drive device such as a motor.

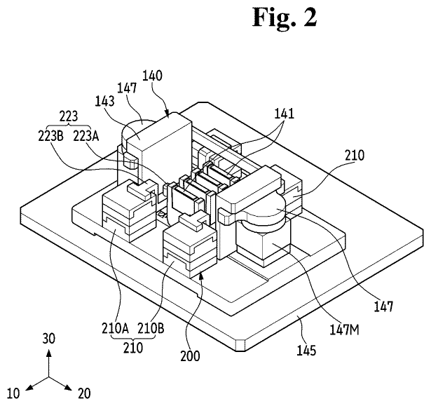

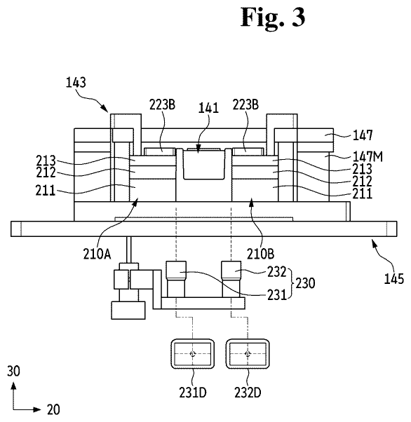

Before explaining the inkjet head unit 140 with reference to FIGS. 2 and 3, the function and installation location of the inkjet head unit 140 will hereinafter be described briefly. The inkjet head unit 140 ejects the substrate treating liquid in the form of droplets onto the substrate G. The inkjet head unit 140 may be installed on a side surface of the gantry unit 130 or the bottom surface of the gantry unit 130.

The inkjet head unit 140 may move along the longitudinal direction of the gantry unit 130, i.e., along the second direction 20, to be positioned at a desired point on the substrate G, but the present disclosure is not limited thereto. The inkjet head unit 140 may also move along the height direction of the gantry unit 130, i.e., along the third direction 30, and may rotate clockwise or counterclockwise. The inkjet head unit 140 may also be fixedly installed on the gantry unit 130. In this case, the gantry unit 130 may be provided to be movable.

Although not illustrated, the substrate treating apparatus 100 may further include an inkjet head moving unit. The inkjet head moving unit may linearly move or rotate the inkjet head unit 140, and may include a drive device such as a motor.

The substrate treating liquid supply unit 150 may be provided as a reservoir for supplying the substrate treating liquid to the inkjet head unit 140. For example, the substrate treating liquid supply unit 150 may be installed on the gantry unit 130 and may include a storage tank 151 and a pressure control module 152.

The storage tank 151 stores the substrate treating liquid, and the pressure control module 152 controls internal pressure of the storage tank 151. The storage tank 151 may supply an appropriate amount of the substrate treating liquid to the inkjet head unit 140 based on the pressure provided by the pressure control module 152.

For example, the storage tank 151 may supply the substrate treating liquid to each of the heads 141 or to each of the nozzles 140N within each of the heads 141, and the pressure control module 152 may control a meniscus of each of the nozzles 140N.

The substrate treating liquid supply unit 150 may be configured as an integrated module with the inkjet head unit 140. For example, the inkjet head unit 140 and the substrate treating liquid supply unit 150 may be arranged on a front surface of the gantry unit 130, and the substrate treating liquid supply unit 150 may be positioned at a higher level than the inkjet head unit 140. However, the present disclosure is not limited to this example.

The substrate treating liquid supply unit 150 may also be configured as a separate module from the inkjet head unit 140. For example, the inkjet head unit 140 and the substrate treating liquid supply unit 150 may be provided separately on the front surface and rear surface, respectively, of the gantry unit 130.

The controller 160 controls the operation of each component (e.g., the process treating unit 110, the gantry unit 130, the inkjet head unit 140, and the substrate treating liquid supply unit 150) of the substrate treating apparatus 100. For example, the controller 160 may control the operations of the air holes 112 of the process treating unit 110, the camera module 125 of the maintenance unit 120, the gantry unit 130, the inkjet head unit 140, and the pressure control module 152 of the substrate treating liquid supply unit 150.

The controller 160 may be implemented as a computer or a server including a process controller, a control program, an input module, an output module, a display module, and/or a memory module.

The process controller may include a microprocessor for performing a control function for each component constituting the substrate treating apparatus 100. The control program may perform various processing operations of the substrate treating apparatus 100 under the control of the process controller. The memory module stores various programs, i.e., processing recipes, to execute various processing operations of the substrate treating apparatus 100 according to various data and processing conditions.

In addition, the controller 160 may also perform a maintenance function for the inkjet head unit 140. For example, based on measurement results from the maintenance unit 120, the controller 160 may correct the ejection position of the substrate treating liquid for each nozzle 140N provided in the inkjet head unit 140 or detect any defective nozzles (i.e., nozzles 140N that do not properly eject the substrate treating liquid) among the nozzles 140N and perform a cleaning operation for such defective nozzles.

In addition, the controller 160 may control an inkjet head alignment apparatus 200 for aligning the heads 141 of the inkjet head unit 140. For example, the controller 160 may control the operations of a drive device 210 and/or a sensor module 230 of the inkjet head alignment apparatus 200.

The inkjet head unit 140 and the inkjet head alignment apparatus 200 will hereinafter be described with reference to the accompanying drawings.

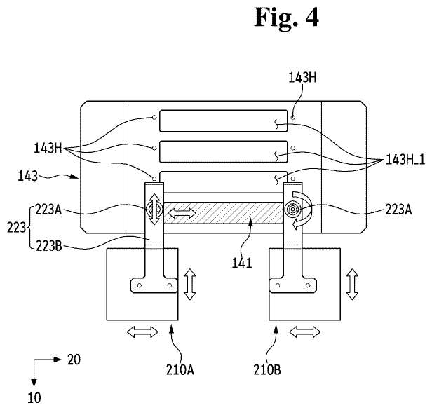

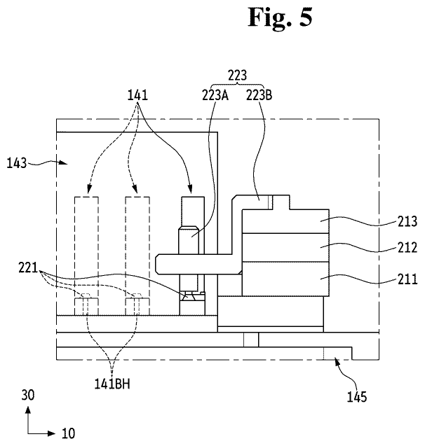

FIG. 2 is a perspective view illustrating the inkjet head unit and the inkjet head alignment apparatus of the substrate treating apparatus according to some embodiments of the present disclosure, FIG. 3 is a front view illustrating the inkjet head unit and the inkjet head alignment apparatus of the substrate treating apparatus according to some embodiments of the present disclosure, FIG. 4 is a plan view illustrating the inkjet head unit and the inkjet head alignment apparatus of the substrate treating apparatus according to some embodiments of the present disclosure, and FIG. 5 is a side view illustrating the inkjet head unit and the inkjet head alignment apparatus of the substrate treating apparatus according to some embodiments of the present disclosure.

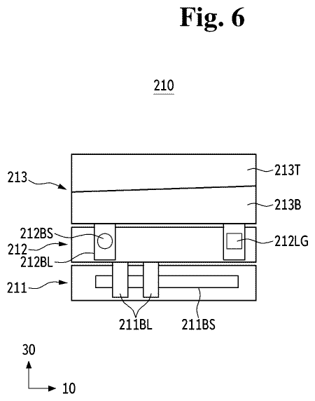

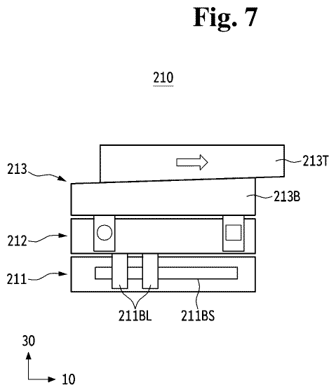

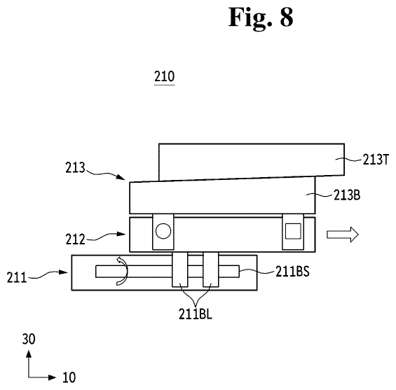

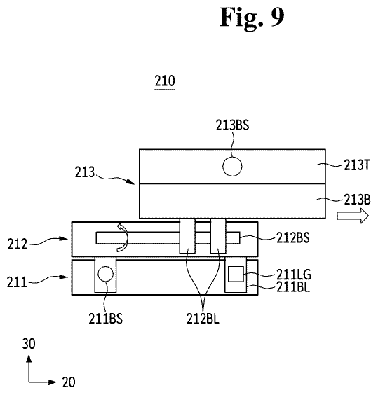

FIG. 6 is a view illustrating an inkjet head alignment apparatus according to a first embodiment of the present disclosure, FIG. 7 is a view illustrating a state where a third motor unit of the inkjet head alignment apparatus according to the first embodiment of the present disclosure operates, FIG. 8 is a view illustrating a state where a first motor unit of the inkjet head alignment apparatus according to the first embodiment of the present disclosure operates, and FIG. 9 is a view illustrating a state where a second motor unit of the inkjet head alignment apparatus according to the first embodiment of the present disclosure operates.

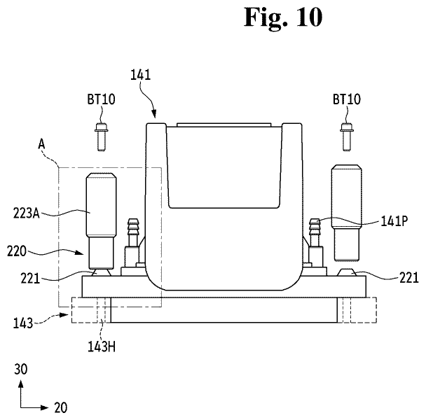

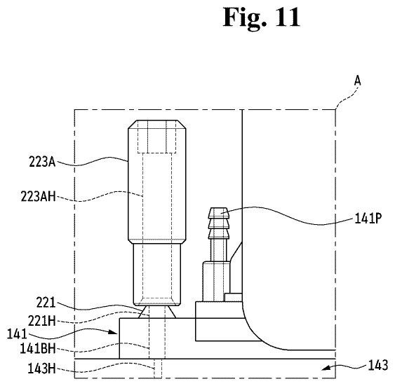

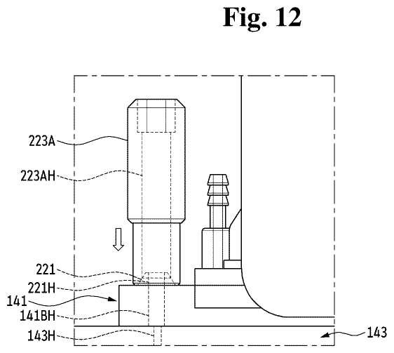

In addition, FIG. 10 is a front view illustrating the inkjet head unit and a bush of the substrate treating apparatus according to some embodiments of the present disclosure, FIG. 11 is an enlarged view illustrating region A of FIG. 10, and FIG. 12 is a front view illustrating a state where the bush is fitted into the inkjet head unit of the substrate treating apparatus according to some embodiments of the present disclosure.

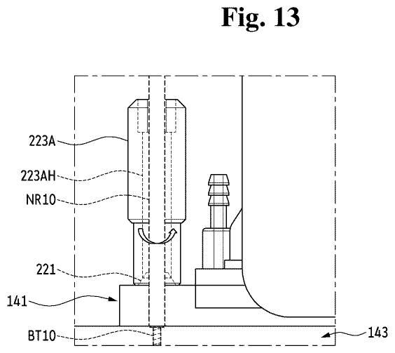

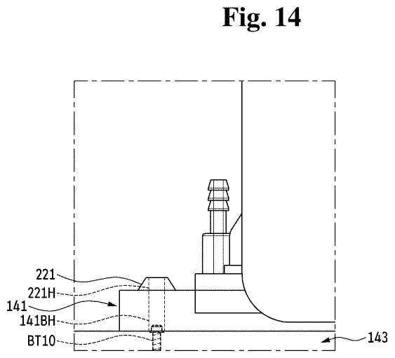

Further, FIG. 13 is a front view illustrating a process of coupling a bolt to the inkjet head unit of the substrate treating apparatus according to some embodiments of the present disclosure, and FIG. 14 is a front view illustrating a state where the bolt is coupled to the inkjet head unit of the substrate treating apparatus according to some embodiments of the present disclosure.

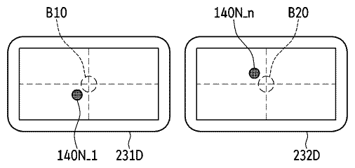

Also, FIG. 15 is a view illustrating a state where a plurality of heads are aligned, and FIG. 16 is a view illustrating a screen of a display device linked to a sensor module of an inkjet head alignment apparatus according to some embodiments of the present disclosure.

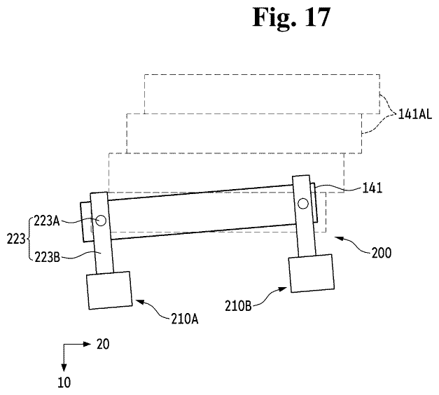

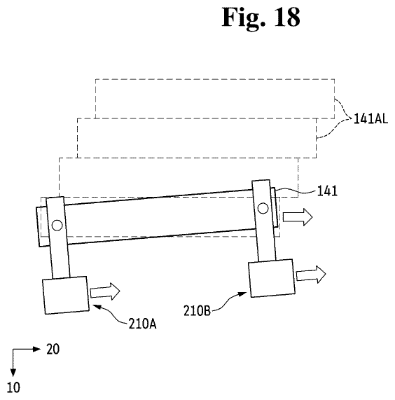

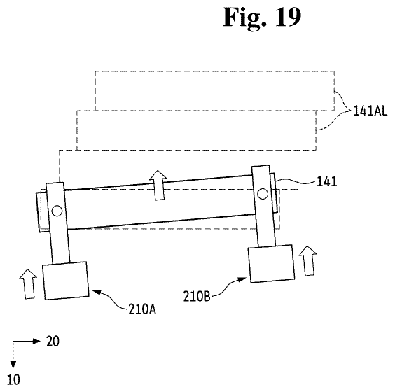

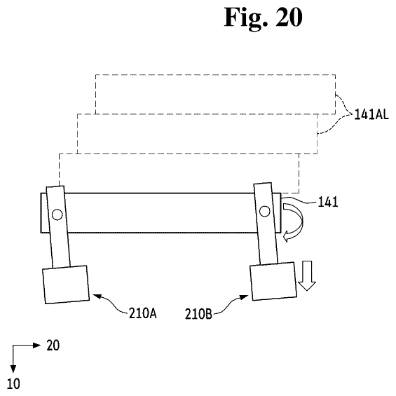

Furthermore, FIG. 17 is a view illustrating a state before heads are aligned in the substrate treating apparatus according to some embodiments of the present disclosure, FIG. 18 is a view illustrating a state where movement in the second direction is formed in the substrate treating apparatus according to some embodiments of the present disclosure, FIG. 19 is a view illustrating a state where movement in the first direction is formed in the substrate treating apparatus according to some embodiments of the present disclosure, and FIG. 20 is a view illustrating a state where movement in a first rotational direction is formed in the substrate treating apparatus according to some embodiments of the present disclosure.

Referring to FIGS. 2 through 20, the heads 141 of the inkjet head unit 140 may be aligned by the inkjet head alignment apparatus 200.

First, the inkjet head unit 140 will now be described. The inkjet head unit 140 may include heads 141, a pack 143, and a base panel 145.

The heads 141 may include ports 141P to which the substrate treating liquid is supplied, as illustrated in FIGS. 10 and 11, and a plurality of nozzles 140N for pixel printing on a substrate G may be provided, as illustrated in FIG. 15.

For example, each of the heads 141 may eject a substrate treating liquid of a specific color such as red color ink, green color ink, or blue color ink onto the substrate G, and the nozzles 140N may be provided in multiple rows and/or columns in the order of red color ink, green color ink, and blue color ink.

Referring to FIGS. 2 and 4, a plurality of heads 141, for example, four heads 141, may be provided in one pack 143. The heads 141 may be formed with the same size.

In addition, the heads 141 may be arranged with a gap D1 (μm) between the first nozzles 140N_1 of adjacent heads 141, as illustrated in FIG. 15. That is, referring to FIG. 15, the heads 141 may be offset from each other by a distance of 50 micrometers or less.

Further, each of the heads 141 may have a bolt hole 141BH formed therein to be coupled to the pack 143 by a bolt BT10, as illustrated in FIG. 11. Referring to FIG. 15, the bolt holes 141BH may be provided in the form of through-holes into which the heads of the bolts BT10 are inserted, or threads may be formed on the inner circumferential surfaces of the bolt holes 141BH to allow the bolts BT10 to be screwed in. Various structures are possible to allow coupling between the heads 141 and the pack 143 by the bolts BT10. In this case, as illustrated in FIG. 11, the pack 143 may have bolt grooves 143H formed on the same center axes as the bolt holes 141BH.

Also, the bolts BT10 may be fastened without threads, using a press-fitting coupling with the pack 143. In this case, various modifications are possible such as forming the bolt holes 141BH and bolt grooves 143H as smooth, unthreaded holes and grooves.

The pack 143 is a structure that groups the heads 141 together and may be installed on the gantry unit 130 via the base panel 145. The pack 143 may expose a plurality of nozzles 140N through its lower surface to eject the substrate treating liquid, and a number of insertion holes 143H_1 corresponding the number of heads 141 may be formed in the pack 143, as illustrated in FIG. 4. That is, the heads 141 may be installed in the respective insertion holes 143H_1 so that the nozzles 140N may be exposed.

Referring to FIGS. 2 and 3, the base panel 145 is illustrated as a single plate, but this is merely for convenience of explanation and understanding. The base panel 145 may be provided as a frame structure and/or a box structure. Various shapes and structures for installation on the gantry unit 130 are possible.

In addition, the base panel 145 may be formed with holes (not illustrated) for exposing the nozzles 140N, similar to the insertion holes 143H_1 of the pack 143. In some embodiments, the base panel 145 may also have the storage tank 151 and the pressure control module 152 installed thereon.

Further, the inkjet head unit 140 may further include a head holder 147 for fixing the pack 143, and a holder driving unit 147M configured to adjust and control the position of the head holder 147. For example, the head holder 147 may include holes for fastening bolts, and the holder driving unit 147M may include a bearing and/or a motor with known technologies applied thereto.

In the inkjet head unit 140, a plurality of heads 141 each provided with a plurality of nozzles 140N may be assembled into the pack 143 for alignment. A head pack (141 and 143) which is a structure where the heads 41 and the pack 43 are integrated, may be provided to the base panel 145 and installed on the gantry unit 130.

Conventionally, typical assembly screws (or bolts) (not illustrated) may be used to align the heads 141 into the pack 143, but since the assembly screws need to be manually operated, the work time may increase. Furthermore, when general heads are assembled into a pack using fastening bolts, distortion may occur due to the fastening torque of the fastening bolts. Since a plurality of heads in an inkjet printing apparatus are arranged with micrometer-level spacing, any distortion of the heads due to fastening torque may cause the nozzles to deviate from their designed positions, resulting in quality problems.

However, according to the present embodiment, the inkjet head alignment apparatus 200 may automatically align the heads 141 without the need of manual alignment. In addition, the inkjet head alignment apparatus 200 may constrain the heads 141 by bush units 223 when bolts BT10 are fastened, thus reducing or preventing distortion of the heads 141 caused by the fastening torque of the bolts BT10.

The inkjet head alignment apparatus 200 for aligning the inkjet head unit 140 will now be described.

The inkjet head alignment apparatus 200 may automatically align the heads 141 of the inkjet head unit 140, and may include a drive device 210, a connection module 220, and a sensor module 230.

The drive device 210 is for aligning the heads 141 in the pack 143. The drive device 210 may form movement in at least two directions, for example, a first direction 10 such as an X-axis direction, a second direction 20 orthogonal to the first direction 10 on a horizontal plane such as a Y-axis direction, or a third direction 30 perpendicular to the first direction 10 such as a Z-axis direction.

For example, the drive device 210 may form movement in all the first, second, and third directions 10, 20, and 30.

The drive device 210 may include a first multi-axis motor module 210A provided at first ends of the heads 141 and a second multi-axis motor module 210B provided at second ends of the heads 141. That is, the first and second multi-axis motor modules 210A and 210B may be provided as a pair at either end of each of the heads 141 for head alignment. The first and second multi-axis motor modules 210A and 210B will be described later with reference to FIGS. 6 through 9.

The connection module 220 is for constraining the heads 141 to the drive device 210. For example, referring to FIGS. 5 and 10 through 14, the connection module 220 may include guide pins 221 and bush units 223.

The guide pins 221 may be provided on the heads 141. For example, the guide pins 221 may be integrally formed at both ends of the heads 141 or separately manufactured and then fixed by an adhesive. The guide pins 221 may protrude in the third direction 30.

The guide pins 221 may be provided on the same center axes as bolt holes 141BH provided in the heads 141 so that the heads 141 may be bolted to the pack 143. Each of the guide pins 221 may be formed with a first through-hole 221H having the same diameter as or a larger diameter than the corresponding bolt hole 141BH. Thus, the bolts BT10 may be inserted and fastened into the bolt holes 141BH of the heads 141 through the first through-holes 221H.

To allow detachable bodies 223A to be easily fitted into and removed from the guide pins 221 after the heads 141 are aligned, and to prevent interference with the guide pins 221 of the aligned heads 141 during movement for aligning adjacent heads 141, the height of the guide pins 221 may be formed lower than the height of the detachable bodies 223A of the bush units 223.

In addition, the guide pins 221 may be tapered to have a smaller diameter toward their tops, and may have, for example, a circular truncated conical shape, to properly guide the detachable bodies 223A. Here, the guide pins 221 may have a diameter and shape corresponding to a lower ends of second through-holes 223AH of the bush units 223 to constrain the bush units 223.

The bush units 223 may be provided on the drive device 210 and may constrain movement in a circumferential direction, including the first and second directions 10 and 20, by receiving the guide pins 221 therein. For example, the bush units 223 may move vertically in response to the operation of third motor units 213 to constrain or release the guide pins 221.

The bush units 223 may include the detachable bodies 223A and connectors 223B.

The detachable bodies 223A may be detachably fitted onto the guide pins 221 and may have a length in the third direction 30. The second through-holes 223AH may be formed in the detachable bodies 223A at positions facing the first through-holes 221H, such that nut runners NR10 may be inserted to fasten the bolts BT10. The second through-holes 223AH may have a larger diameter than the bolts BT10 and the nut runners NR10 to allow their insertion.

The connectors 223B may connect the detachable bodies 223A to the drive device 210. For example, first ends of the connectors 223B may be connected to the detachable bodies 223A, and second ends of the connectors 223B may be connected to the drive device 210. The connectors 223B may be provided as single bars. Alternatively, as illustrated in FIG. 5, the connectors 223B may be bent or curved to be connected to the centers of the detachable bodies 223A. Various shapes and structures are possible for connecting the detachable bodies 223A and the drive device 210.

The sensor module 230 is for detecting the heads 141, the nozzles 140N, and/or alignment marks (not illustrated) to automatically align the heads 141. That is, the sensor module 230 may detect or recognize the heads 141, the nozzles 140N, and/or the alignment marks. For example, the sensor module 230 may include a first vision camera 231 and a second vision camera 232.

Referring to FIG. 3, the first vision camera 231 may be placed near the first ends of the heads 141 to detect first nozzles 140N_1 of the heads 141, first edges of the heads 141, and/or alignment marks. The second vision camera 232 may be placed near the second ends of the heads 141 to detect last nozzles 140N_n of the heads 141, second edges of the head 141, and/or alignment marks (not illustrated).

In the following description, it is assumed that as the sensor module 230 recognizes the nozzles 140N, the first vision camera 231 recognizes the first nozzles 140N_1 of the heads 141, and the second vision camera 232 recognizes the last nozzles 140N_n of the heads 141.

Each of the first and second vision cameras 231 and 232 may acquire image information similarly to the camera module 125. That is, the sensor module 230 may recognize the nozzles 140N by acquiring image information regarding the nozzles 140N.

The image information of the nozzles 140N acquired by the sensor module 230 may be compared with preset positions B10 and B20 of the first nozzles 140N1 and last nozzles 140N_n, stored in the sensor module 230 and/or the controller 160.

For example, referring to FIG. 16, if the position information of the first nozzles 140N_1 and last nozzles 140N_n, displayed by first and second display devices 231D and 232D linked to the first and second vision cameras 231 and 232, does not match the preset positions B10 and B20, the drive device 210 may operate such that the position information the first nozzles 140N_1 and last nozzles 140N_n may match the preset positions B10 and B20.

By recognizing the nozzles 140N, the first and second vision cameras 231 and 232 of the sensor module 230 may determine how far the heads 141 deviate from the preset position information (B10 and B20). Thus, the controller 160 may control the operation of the drive device 210 in the first and second directions 10 and 20 based on the image data received from the sensor module 230. Through such operation of the drive device 210, the second through-holes 223AH of the bush units 223 may be aligned with the first through-holes 221H of the guide pins 221 and the bolt holes 141BH of the heads 141 on the same center axes, thereby aligning the heads 141.

The drive device 210 may operate each of the heads 141 individually for alignment and may include the first and second multi-axis motor modules 210A and 210B, which are provided as multi-axis motors.

In other words, the drive device 210 may include the first and second multi-axis motor modules 210A and 210B, which are provided as multi-axis motors enabling coupling/decoupling of the heads 141 through movement in the third direction 30 while causing moving in the first and second directions 10 and 20.

Here, the multi-axis motors may each be provided as a combination of a first motor unit 211, a second motor unit 212, and/or a third motor unit 213 that form movement in the first direction 10, the second direction 20, and the third direction 30, respectively. Thus, various modifications of the first and second multi-axis motor modules 210A and 210B may be possible. For example, each of the first and second multi-axis motor modules 210A and 210B may be provided as a combination of the first, second, and third motor units 211, 212, and 213, but the present disclosure is not limited thereto.

Each of the first and second multi-axis motor modules 210A and 210B may be fitted onto both the first ends and second ends of the heads 141 via the bush units 223 and may be synchronized mechanically or under the control of the controller 160 such that movement in the first and second directions 10 and 20 may be formed. However, synchronization may be performed selectively. For example, when the second multi-axis motor module 210B operates the heads 141 in a first rotational direction (i.e., a θ direction), the first multi-axis motor module 210A may remain stationary while the second multi-axis motor module 210B is forming movement in the first direction 10.

For example, the first multi-axis motor module 210A may include first and second motor units 211 and 212 to form movement in the first and second directions 10 and 20, and may further include a third motor unit 213 to form movement in the third direction 30.

Meanwhile, the second multi-axis motor module 210B may be synchronized physically or under control with the first multi-axis motor module 210A such that when the first ends of the heads 141 are adjusted in the first and second directions 10 and 20 by the operation of the first multi-axis motor module 210A, movement in the first and second directions 10 and 20 may also be formed at the second ends of the heads 141 via the bush unit 223 connected to the second ends of the heads 141. At this time, the second multi-axis motor module 210B may achieve head alignment in the first rotational direction through movement in the first direction 10 relative to the first multi-axis motor module 210A, which serves as an axis, to rotate the second ends of the heads 141 in the first rotational direction, i.e., to align the heads 141 through manipulation in the first rotational direction. To achieve head alignment in the first rotational direction, the second multi-axis motor module 210B may include a first motor unit 211 and, for coupling/decoupling the corresponding bush unit 223, may further include a third motor unit 213. Various modifications of the second multi-axis motor module 210B may be possible such as omitting the second motor unit 212 of the second multi-axis motor module 210B.

In the following description, it is assumed that each of the first and second multi-axis motor modules 210A and 210B is provided as a combination of first, second, and third motor units 211, 212, and 213. In other words, it is assumed that each of the first and second multi-axis motor modules 210A and 210B is provided as a three-axis motor in which first, second, and third motor units 211, 212, and 213 are vertically stacked.

First, second, and third motor units 211, 212, and 213 will hereinafter be described.

Referring to FIGS. 6 through 9, the first motor unit 211 may form movement in the first direction 10, the second motor unit 212 may form movement in the second direction 20, and the third motor unit 213 may form movement in the third direction 30.

For example, each of the first and second motor units 211 and 212 may be provided as a linear motor module. In this example, the first motor unit 211 may include a first linear guide 211LG and/or a first ball screw 211BS extending along the first direction 10, and a first block 211BL, which is movable along the first linear guide 211LG and/or the first ball screw 211BS and connected to the second motor unit 212 to move the second motor unit 212 in the first direction 10.

In addition, the second motor unit 212 may include a second linear guide 212LG and/or a second ball screw 212BS extending along the second direction 20, and a second block 212BL movable along the second linear guide 212LG and/or the second ball screw 212BS and connected to the third motor unit 213 to move the third motor unit 213 in the second direction 20.

Further, the third motor unit 213 may adjust its height by the sliding of an upper member 213T or a lower member 213B along an inclined surface formed between opposing surfaces of the upper and lower members 213T and 213B. Here, a third ball screw 213BS may be provided on either the upper member 213T or the lower member 213B, such that one of the upper and lower members 213T and 213B may move relative to the other by the rotation of the third ball screw 213BS. However, this is merely exemplary. Various modifications are possible such as providing a third ball screw (not illustrated) upright in the third direction 30 and a third block (not illustrated) moving up and down according to the operation of the ball screw to adjust the height of the third motor unit 213.

In other words, multi-axis motors according to this embodiment are merely exemplary, and are not limited to linear motor modules. Also, the vertical arrangement of the first, second, and third motor units 211, 212, and 213 is merely exemplary for convenience of explanation and understanding and is not limiting.

Additionally, although not illustrated, each of the first, second, and third ball screws 211BS, 212BS, and 213BS may receive power from a drive device such as a motor to be rotated, but this is merely one example and is not limiting.

The operation of the inkjet head alignment apparatus 200 including the first and second multi-axis motor modules 210A and 210B, which are provided as multi-axis motors, will hereinafter be described.

Referring to FIGS. 16 and 17, when the positions of first and last nozzles 140N_1 and 140N_n of a head 141 detected by the first and second vision cameras 231 and 232 deviate from the preset positions B10 and B20, the head 141 needs to be aligned.

Here, by aligning the positions of the first and last nozzles 140N_1 and 140N_n with the preset positions B10 and B20, the head 141 may be aligned to a preset position 141AL in FIG. 17.

Thus, for the head 141 that needs to be aligned, the first and last nozzles 140N_1 and 140N_n of the head 141 may be aligned to the preset positions B10 and B20 by the operation of the inkjet head alignment apparatus 200. For this, the drive device 210 may form movement in the first, second, and third directions 10, 20, and 30.

Specifically, referring to FIGS. 11, 12, and 17, the drive device 210 may constrain the heads 141 by moving the bush units 223, i.e., fitting the guide pins 221 onto the bush units 223, to link the heads 141 provided with the guide pins 221 to movement in the first direction 10 and/or the second direction 20 of the drive device 210.

To this end, the third motor units 213 of the first and second multi-axis motor modules 210A and 210B may move downward to fit the bush units 223 onto the guide pins 221, but the present disclosure is not limited thereto. Various modifications are possible. For example, various modifications are possible such as initially arranging, by an operator, the bush units 223 to be fitted onto the guide pins 221.

Referring to FIGS. 18 and 19, after the heads 141 are constrained by the drive device 210, that is, after the guide pins 221 are fitted into the bush units 223 connected to the first and second multi-axis motor modules 210A and 210B, the drive device 210 may form movement in the first or second directions 10 or 20. Since movement in the first and second directions 10 and 20 is for head alignment, the sequence of movement in the first and second directions 10 and 20 is not limited.

For example, referring to FIG. 18, movement in the second direction 20 may be formed first, and then, referring to FIG. 19, movement in the first direction 10 may be formed. For this, the second motor unit 212 of the first multi-axis motor module 210A may first operate, and the first motor unit 211 of the first multi-axis motor module 210A may operate simultaneously or subsequently. Here, the first and second multi-axis motor modules 210A and 210B may be in a state of being mechanically synchronized via the bush units 223 connected to the first ends and second ends, respectively, of the heads 141, or in a state of being control-synchronized by the controller 160, but the present disclosure is not limited thereto.

After the heads 141 are moved by the drive device 210 in the first and second directions 10 and 20, the first multi-axis motor module 210A may remain fixed as a reference/axis for forming movement in the first rotational direction, while the second multi-axis motor module 210B may operate.

In other words, referring to FIG. 20, while the first multi-axis motor module 210A remains stationary, the first motor unit 211 of the second multi-axis motor module 210B may form movement in the first direction 10, thereby rotating the second ends of the heads 141 in the first rotational direction relative to the first ends.

Once the heads 141 are aligned to match the preset positions B10 and B20 by the operation of the drive device 210, the bolts BT10 may be fastened.

For example, referring to FIG. 13, the nut runners NR10 may be inserted through the second through-holes 223AH of the bush units 223, the first through-holes 221H of the guide pins 221, and/or the bolt holes 141BH of the heads 141, to fasten the bolts BT10 into the bolt grooves 143H of the pack 143.

In this embodiment, since the bush units 223 constrain the circumferential movement of the heads 141 when the bolts BT10 are fastened to the pack 143, distortion caused by fastening torque may be reduced.

In this embodiment, the drive device 210 is for aligning multiple heads 141. When one of the multiple heads 141 is aligned, the drive device 210 may be configured to form movement in an upward direction to release the bush units 230 from the aligned head 141 during the movement of the third motor unit 213 in the third direction 30. Then, the bush units 223 may be separated from the guide pins 221 of the aligned head 141 e third motor unit 213 may move upward in the third direction 30 to release the bush unit 223 from the guide pins 221 of the aligned head 141. Then, this alignment process may be repeated for an adjacent head 141 requiring alignment.

In addition, the inkjet head alignment apparatus 200 may be provided to the substrate treating apparatus 100 during initial installation of the heads 141, used to align the heads 141, and then removed.

However, the present disclosure is not limited to this, and various modifications are possible. For example, if a printing position error or targeting accuracy error of the substrate treating liquid occurs based on image information acquired by the camera module 125, the inkjet head alignment apparatus 200 may be reinstalled to re-align the heads 141.

Alternatively, the inkjet head alignment apparatus 200 may remain installed on the substrate treating apparatus 100 even after the heads 141 are aligned, allowing the heads 141 to be re-aligned whenever needed.

Although embodiments of the present disclosure have been described above with reference to the accompanying drawings, it will be understood by one of ordinary skill in the art that various modifications can be made without departing from the technical spirit or essential features of the present disclosure. Therefore, it should be understood that the above-described embodiments are illustrative in all respects and not restrictive.

What is claimed is:

1. An inkjet head alignment apparatus comprising:
a drive device configured to align heads for ejecting a substrate treating liquid; and
a connection module configured to constrain the heads to the drive device,
wherein
the drive device is configured to form movement in at least two directions among a first direction, a second direction orthogonal to the first direction on a horizontal plane, and a third direction perpendicular to the first direction in an upward direction, and
the connection module comprises: guide pins provided on the heads and protruding in the third direction; and bush units provided on the drive device and configured to constrain movement in a circumferential direction, including the first and second directions, by receiving the guide pins therein.

2. The inkjet head alignment apparatus of claim 1, wherein the drive device comprises a first multi-axis motor module provided at first ends of the heads and a second multi-axis motor module provided at second ends of the heads.

3. The inkjet head alignment apparatus of claim 2, wherein the drive device comprises: a first motor unit configured to form movement in the first direction; a second motor unit configured to form movement in the second direction; and a third motor unit configured to form movement in the third direction.

4. The inkjet head alignment apparatus of claim 3, wherein
the heads are arranged to extend along the second direction,
the first multi-axis motor module is positioned closer to the first ends of the heads than to the second ends and moves the first ends of the heads in the second direction by including the second motor unit, and
the second multi-axis motor module is positioned closer to the second ends of the heads than to the first ends and moves the second ends of the heads by including the first motor unit.

5. The inkjet head alignment apparatus of claim 4, wherein the second multi-axis motor module is configured such that the first motor unit forms movement in the first direction with the first multi-axis motor module or the connection module as an axis.

6. The inkjet head alignment apparatus of claim 4, wherein each of the first and second multi-axis motor modules further comprises the third motor unit.

7. The inkjet head alignment apparatus of claim 6, wherein the bush units are configured to move in an up-down direction according to an operation of the third motor units of the first and second multi-axis motor modules and to constrain or release the guide pins.

8. The inkjet head alignment apparatus of claim 6, wherein the first multi-axis motor module further comprises the first motor unit.

9. The inkjet head alignment apparatus of claim 8, wherein the second multi-axis motor module further comprises the second motor unit.

10. The inkjet head alignment apparatus of claim 9, wherein in each of the first and second multi-axis motor modules, the first, second, and third motor units are vertically stacked.

11. The inkjet head alignment apparatus of claim 1, wherein each of the guide pins is provided on the same center axis as a bolt hole provided in a corresponding head for bolting the corresponding head to a pack, and is formed with a first through-hole having the same diameter as or a larger diameter than the bolt hole.

12. The inkjet head alignment apparatus of claim 11, wherein each of the bush units comprises: a detachable body fitted onto a guide pin and extending in the third direction; and a connector configured to connect the detachable body to the drive device.

13. The inkjet head alignment apparatus of claim 12, wherein a second through-hole penetrating in an up-down direction is formed in the detachable body at a position facing the first through-hole.

14. The inkjet head alignment apparatus of claim 1, wherein the guide pins are tapered to have a smaller diameter toward their tops.

15. The inkjet head alignment apparatus of claim 14, wherein the guide pins have a smaller height than the bush units.

16. The inkjet head alignment apparatus of claim 1, further comprising:
a sensor module configured to detect nozzles or edges of the heads,
wherein the drive device is configured to align the heads such that positions of the nozzles or the edges of the heads detected by the sensor module match preset positions set as correct positions of the nozzles or edges of the heads.

17. The inkjet head alignment apparatus of claim 16, wherein the sensor module comprises: a first vision camera arranged adjacent to first ends of the heads; and a second vision camera arranged adjacent to second ends of the heads.

18. The inkjet head alignment apparatus of claim 1, wherein the drive device is configured to align multiple heads arranged in a pack.

19. An inkjet head alignment apparatus comprising:
a sensor module comprising a first vision camera arranged closer to first ends than to second ends of heads configured to eject a substrate treating liquid provided for a color filter, and a second vision camera arranged closer to the second ends than to the first ends of the heads, the sensor module being configured to detect nozzles of the heads;
a drive device configured to align the heads in a pack such that positions of the nozzles detected by the sensor module match preset positions set as correct positions of the nozzles; and
a connection module configured to constrain the heads to the drive device,
wherein
the drive device comprises: a first multi-axis motor module provided at the first ends of the heads; and a second multi-axis motor module provided at the second ends of the heads,
each of the first and second multi-axis motor modules comprises: a first motor unit configured to form movement in a first direction; a second motor unit configured to form movement in a second direction orthogonal to the first direction on a horizontal plane; and a third motor unit configured to form movement in a third direction perpendicular to the first direction in an upward direction,
the connection module comprises: guide pins provided on the heads, protruding in the third direction, and having a circular truncated cone shape tapered to have a smaller diameter toward their tops, wherein each of the guide pins is provided on a same center axis as a bolt hole provided in a corresponding head for bolting the corresponding head to a pack and has a first through-hole with the same diameter as or a larger diameter than the bolt hole; and bush units provided on the drive device, configured to move in an up-down direction by operation of the third motor units of the first and second multi-axis motor modules, configured to constrain the guide pins when the guide pins are inserted thereinto and thereby constrain movement in a circumferential direction, including the first and second directions, and have a greater height than the guide pins, and
each of the bush units comprises: a detachable body fitted onto a corresponding guide pin, extending in the third direction, and having a second through-hole penetrating in the up-down direction at a position facing the first through-hole; and a connector configured to connect the detachable body to the drive device.

20. A substrate treating apparatus comprising:
a process treating unit configured to support a substrate;
an inkjet head unit comprising heads configured to eject a substrate treating liquid onto the substrate and arranged in a pack; and
a substrate treating liquid supply unit configured to supply the substrate treating liquid to the inkjet head unit,
wherein the heads are aligned by the inkjet head alignment apparatus of claim 1.
